(19) United States
(12) Patent Application Publication
(10) Pub. No.: US 2021/0214950 A1
(43) Pub. Date: Jul. 15, 2021

(54) SEMI-AUTOMATIC AWNING WITH SPRING

(71) Applicant: Hyung Chil LEE, Anseong-Si (KR)

(72) Inventor: Hyung Chil LEE, Anseong-Si (KR)

(21) Appl. No.: 17/148,901

(22) Filed: Jan. 14, 2021

(30) Foreign Application Priority Data
Jan. 15, 2020 (KR) 10-2020-0005618

(51) Int. Cl. E04F 10/06

(52) U.S. Cl. CPC E04F 10/0666; E04F 10/0685

(57) ABSTRACT

A semi-automatic awning with a spring according to the present invention includes a body case in which an awning sheet is installed to be withdrawn and retracted, a winding pipe on which the awning sheet is wound, a pipe-spring connector configured to connect the winding pipe and a tension spring, a tension spring central axis for providing tension for withdrawal and retraction of the awning sheet, a plurality of male gears and female gear which are involved in the withdrawal and retraction of the awning sheet and control a connection of the winding pipe and the tension spring central axis, and an operation knob which can change a connection position of the winding pipe and the tension spring. Thereby, the length of the awning sheet may be freely adjusted while capable of easily unwinding and winding the awning sheet by adding an adjustable spring force to the manual force, and the partially unwound state may be easily fixed, and thereby anyone of any age and gender can easily use.

### RELATED APPLICATIONS

This application claims priority to Korean Patent Application No. 10-2020-0005618, filed on Jan. 15, 2020 in the Korean Intellectual Property Office, the entire disclosure of which is incorporated herein by reference.

### BACKGROUND OF THE INVENTION

### 1. Field of the Invention

The present invention relates to a semi-automatic awning with a spring for a shade and a water blocking plate, which can be easily unwound and wound using springs.

### 2. Description of the Related Art

Awnings are mainly installed on terraces or on exterior decks of commercial buildings and houses with stores, and in particular, are installed on campers to be used to secure areas for a shade and a water blocking plate these days.

Until now, the awnings are divided into an electric awning that can be wound and unwound by a motor, a manual awning that can be wound and unwound by hand, and a semi-automatic awning that can be unwound by turning gears using an iron rod.

In a case of the electric awning, which is known as the most advanced of them, first, it is expensive. In addition, since it is an electric device, due to an unexpected failure of the motor or sensor, an awning sheet may not suddenly fold at the moment of leaving after camping, which may lead to a difficult situation for users. Since many of these cases have been posted on the Internet, many consumers end up choosing a manual or semi-automatic awning. In this way, the user also should directly roll up the selected manual awning or the awning sheet. However, it may be impossible to perform this action alone, such that two persons may have to work together. Since a length of the awning sheet is also fixed in a constant range, although the user may like to use it fully extended in a wide area or partially extended in a narrow area, it cannot meet such expectations. Further, there are several disadvantages such as fluttering of the unwound awning sheet by wind or an external force.

### SUMMARY OF THE INVENTION

Accordingly, it is an object of the present invention to provide a semi-automatic awning with a spring, which uses an adjustable spring force as a manual force, such that anyone of any age and gender can unfold and wind an awning sheet, as well as freely adjust a length of the awning sheet, and is equipped with a stopper device for stopping the unwinding and winding.

To achieve the above-described object, according to an aspect of the present invention, there is provided a semi-automatic awning with a spring, including:

a body case which includes an awning sheet wound and accommodated therein, an opening formed on a front side for withdrawing the awning sheet, side openings formed at opposite ends thereof, and axis fixing parts configured to close the side openings, to which axes are coupled inside thereof;

a winding pipe which is a hollow pipe, and is rotatably installed in a first axis fixing part on one side of the body case, wherein the awning sheet is wound on an outer circumference thereof, and a tension spring is accommodated therein, thus to transmit a rotational force of the tension spring to the awning sheet;

a pipe-spring connector configured to connect the winding pipe and the tension spring, which is a main member to generate the rotational force;

a tension spring central axis having a plurality of male gears which are formed on one side while penetrating the tension spring at a central portion of the awning and are configured to control rotation of the tension spring;

the tension spring accommodated in the winding pipe and coupled with a tension spring central axis connected with an operation knob therein to store and dissipate an elastic force as a basis of the rotational force;

a plurality of male gears having a circular outer gear shape, which are formed on one side of the tension spring central axis at a predetermined interval, and are selectively meshed with a plurality of female gears to selectively control the rotational force of the tension spring transmitted to the winding pipe;

the plurality of female gears having a circular inner circumferential gear shape, which are coupled to one end of the winding pipe and a second axis fixing part on the other side of the body case, and are selectively meshed with the plurality of male gears; and

the operation knob which is pivotably and eccentrically coupled to one end of the tension spring central axis adjacent to the plurality of male gears and female gears on an outside of the body case, and is configured to move the tension spring central axis to any one of a first position where one of the plurality of male gears is meshed with a female gear provided in the second axis fixing part, a second position where all of the plurality of male gears and female gears are meshed with each other, and a third position where all of the plurality of male gears and female gears are separated from each other,

wherein in the first position, rotation of the winding pipe is allowed and rotation of the tension spring central axis is prevented, in the second position, rotations of both the winding pipe and tension spring central axis are prevented, and in the third position, the rotational force of the tension spring may be adjusted by rotating the tension spring central axis coupled with the operation knob.

The plurality of male gears and female gears can be easily coupled and separated by a tensile force of the tension spring central axis generated by a compressive force of the compression spring located between the male gear and the female gear coupled to the second axis fixing part.

The female gear may include a first female gear located in the second axis fixing part and a second female gear located in the winding pipe, and the first female gear having an inner circumferential shape may be a gear formed longer than the second female gear so that the first female gear is meshed with the male gear located on the first axis fixing part in a state in which the tension spring central axis is converted from the first position to the second position.

The operation knob may include: a first contact section configured to contact with the second axis fixing part by moving the tension spring central axis with respect to a rotation central portion rotatably coupled to the tension spring central axis to make it into the first position; a second contact section disposed to cross the first contact section at a right angle, and configured to move the tension spring central axis into the second position; and a third contact section disposed to cross the second contact section at a right angle, and configured to move the tension spring central axis into the third position.

The position of a central axis of the operation knob may be set so that a suitable difference is generated in a distance between the central axis of the operation knob and the first, second and third contact sections so as to correspond to the first, second and third positions.

The operation knob may include the first, second and third contact sections, and may have a rectangular block shape having rounded corners for pivot operation.

The awning sheet may have a ceiling portion and a wall awning sheet portion which are integrally formed with each other, thus to be used as the ceiling portion up to the wall awning sheet portion depending on circumstances, and punched holes are formed in the middle to freely adjust the length of the awning sheet.

According to the present invention, the spring force is used in addition to the manual force while unwinding and winding the awning sheet, such that anyone of any age and gender can unfold and wind the awning sheet, and freely adjust the length of the unwound awning sheet according to the place or environment, as well as it is possible to easily fix the partially unwound awning sheet, and prevent the awning sheet in the fixed state form fluttering due to the tension.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a conceptual diagram illustrating a first position of a semi-automatic awning with a spring according to an embodiment of the present invention;

FIG. 2 is a conceptual diagram illustrating a second position changed from the position of FIG. 1;

FIG. 3 is a conceptual diagram illustrating a third position changed from the position of FIG. 2; and

FIG. 4 is a conceptual diagram illustrating a state in which unwinding of an awning sheet from the first position of FIG. 1 to the second position is completed.

### DETAILED DESCRIPTION OF THE INVENTION

Hereinafter, a semi-automatic awning with a spring according to an embodiment of the present invention, which has a high practical implementation and industrial applicability, will be described with reference to the accompanying drawings.

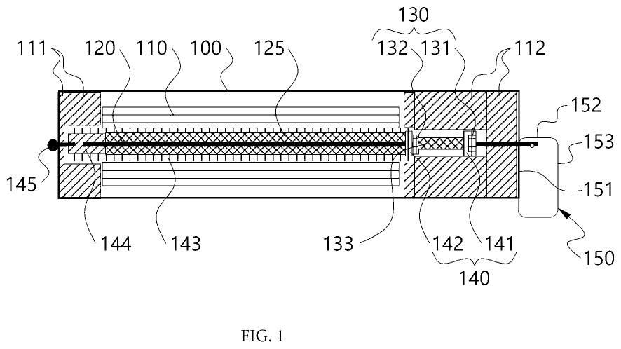

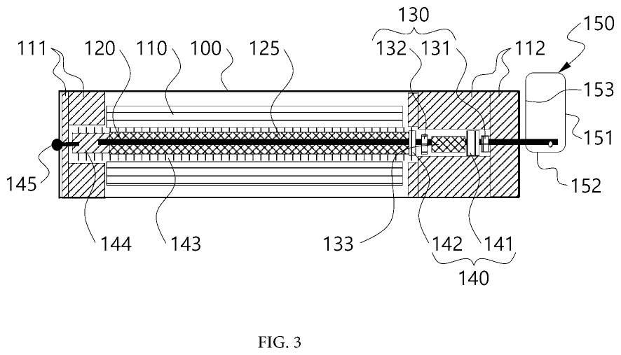

Referring to FIGS. 1 to 3, the semi-automatic awning with a spring according to an embodiment of the present invention includes: a body case 100 in which an awning sheet 110 is installed to be withdrawn and retracted, a winding pipe 143 on which the awning sheet 110 is wound; a pipe-spring connector 144 configured to connect the winding pipe 143 and a tension spring 125; a tension spring central axis 120 configured to assist a fixation of the tension spring 125 and operations of a plurality of male gears 130 and an operation knob 150; the tension spring 125 configured to provide tension for withdrawal and retraction of the awning sheet 110; a plurality of male gears 130 and female gears 140 which are involved in the withdrawal and retraction of the awning sheet 110 and control a connection of the winding pipe 143 and the tension spring central axis 120; and the operation knob 150 which can change a connection position of a compression spring 133, the winding pipe 143 and the tension spring central axis 120 by maintaining the tension of the plurality of male gears 130 and the operation knob 150.

The awning sheet 110 is accommodated and wound in an inner space of the body case 100 which includes an opening formed on a front side for withdrawing the awning sheet 110, side openings formed at opposite ends thereof, and axis fixing parts 111 and 112 for closing the side openings, to which axes are fixed inside thereof.

One of the axis fixing parts 111 and 112, which is disposed on a left side, is a first axis fixing part 111 which rotatably accommodates the winding pipe 143, wherein the pipe-spring connector 144 inserted into the winding pipe 143 is rotatably coupled to an end thereof.

One end of the pipe-spring connector 144 is coupled to the winding pipe 143, and the other end is rotatably coupled to the first axis fixing part 111 by a screw.

One end of the winding pipe 143 is coupled to the pipe-spring connector 144, and is rotatably installed in the first axis fixing part 111, which is an axis fixing part on one side of the body case 100. The awning sheet 110 is wound on an outer circumference of the winding pipe 143 having a hollow shape in which the tension spring 125 is accommodated. Herein, the awning sheet 110 is wound by a rotational force of the tension spring 125.

The other end of the winding pipe 143 has one of the plurality of female gears 140 provided therein, and is rotatably coupled to the end of a second axis fixing part 112 to stabilize the tension spring central axis 120, which will be described below.

The winding pipe 143 transmits the rotational force of the tension spring 125 to the winding pipe 143 without addition or subtraction, and not only facilitates winding and unwinding of the awning sheet 110, but also may be composed of a circular or square-shaped or grooved steel material or plastic pipe that can sufficiently withstand the weight of the awning sheet 110.

The second axis fixing part 112, which is an axis fixing part on the other side of the body case 100, has one of the plurality of female gears 140 to be described below, and is coupled with the female gear 142 provided in the winding pipe 143 to fix the tension spring central axis 120.

The body case 100 has a cylindrical shape or an angled shape capable of providing an inner space in which the awning sheet 110 can be accommodated, and may be made of steel, synthetic fiber, or plastic containing fiber material.

The tension spring central axis 120 is wrapped in the tension spring 125, and whose one end is rotatably coupled to the pipe-spring connector 144 in a slider manner, and the other end extends through the opening on the other side of the body case 100 along a center line of the body case 100 and protrudes to an outside of the body case 100, to which the operation knob 150 is pivotably connected.

The plurality of male gears 130 are installed on the tension spring central axis 120 at a predetermined interval, and move to right or left along a center axis of the body case 100 by the operation knob 150, such that the male gear 130 and the female gear 140 are selectively engaged and disengaged.

One end of the tension spring 125 is coupled to the tension spring central axis 120 to be accommodated in the winding pipe 143, and the other end thereof is coupled to the pipe-spring connector 144, such that it is possible to receive the rotational force from both sides or transmit the same to both sides.

The tension spring 125 is disposed inside the winding pipe 143 while surrounding the tension spring central axis 120, and may provide a pre-set rotational force of the tension spring to the winding pipe 143 by selectively connecting the plurality of male gears 130 and female gears 140.

When the awning sheet 110 is unwound with being wound around the winding pipe 143 and is withdrawn to the outside of the body case 100, that is, when the end of the awning sheet 110 is pulled to unfold the awning sheet 110, the winding pipe 143 is immediately rotated due to unwinding of the awning sheet 110, and the tension spring 125 connected to one end of the winding pipe 143 is wound and an elastic force corresponding to the rotational force may be stored. Conversely, if the end of the released awning sheet 110 is held and released loosely, the elastic force stored in the above operation is applied as the rotational force to rotate the winding pipe 143, and the awning sheet 110 is wound by itself in connection therewith.

The plurality of male gears 130 are located adjacent to the second axis fixing part 112 on the other side of the body case 100, are coupled to the other side of the tension spring central axis 120 at a predetermined interval, and may have a circular outer gear shape corresponding to the first contact position 151, the second contact position 152, and the third contact position 153, which are adjusted by the operation knob 150 connected to the end of the tension spring central axis 120.

The plurality of male gears 130 may include a first male gear 131 and a second male gear 132, and the first male gear 131 and the second male gear 132 may have rounded corners so as to be smoothly meshed with the female gear 140.

The plurality of female gears 140 are respectively provided on the winding pipe 143 and the second axis fixing part 112 of the body case 100, are arranged at positions corresponding to the plurality of male gears 130, and have a circular inner gear shape.

The female gear 140 includes a first female gear 141 located in the second axis fixing part 112 and a second female gear 142 located in the winding pipe 143. Herein, the first female gear 141 may be a gear formed longer than the second female gear 142 so that all of the plurality of male gears 130 and the female gear 140 are meshed in a state in which the tension spring central axis 120 is converted from the first position to the second position.

The compression spring 133 is installed between the second axis fixing part 112 and the second male gear 132 to enlarge a gap therebetween while pushing the same, so that the operation knob 150 operates smoothly, and allows the plurality of male gears 130 moved by the operation knob 150 to be stopped at the manipulated position.

The operation knob 150 is pivotably and eccentrically coupled to one end of the tension spring central axis 120 adjacent to the plurality of male gears 130 and the female gears 140 on the outside of the body case 100.

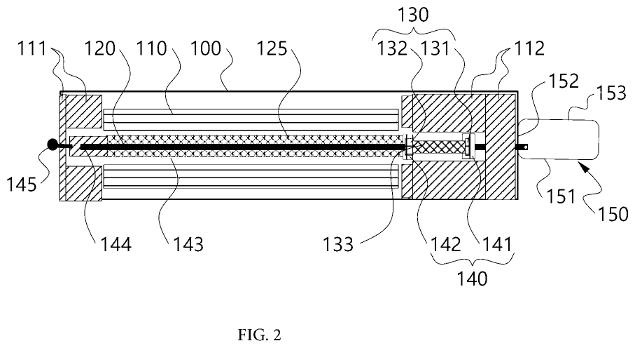

In a state in which the tensile force is maintained by the compression spring 133, the operation knob 150 moves the tension spring central axis 120 to any one of the first position where one of the plurality of male gears 130 is meshed with the first female gear 141 provided in the second axis fixing part 112 as shown in FIG. 1, the second position where all of the plurality of male gears 130 and the female gears 140 are meshed with each other as shown in FIG. 2, and the third position where all of the plurality of male gears 130 and the female gears 140 are separated from each other.

According to the present embodiment, in the first position of the tension spring central axis 120 for unwinding the awning sheet 110, the winding pipe 143 is allowed to rotate and rotation of the tension spring center axis 120 is prevented, in the second position for fixing the unwinding of the awning sheet 110, rotation of both the winding pipe 143 and the tension spring central axis 120 is prevented, and in the third position for pre-setting the spring force of the tension spring 125, the rotational force of the tension spring 125 may be adjusted by rotating the tension spring central axis 120.

Meanwhile, the operation knob 150 may include: a first contact section 151 configured to contact with the second axis fixing part 112 by moving the tension spring central axis 120 with respect to a rotation central portion rotatably coupled to the tension spring central axis 120 to make it into the first position; a second contact section 152 disposed to cross the first contact section 151 at a right angle, and configured to move the tension spring central axis 120 into the second position; and a third contact section 153 disposed to cross the second contact section 152 at a right angle, and configured to move the tension spring central axis 120 into the third position.

Such the operation knob 150 may have the first, second and third contact sections corresponding to the first, second and third positions, and may have a rectangular block shape with rounded corners for pivot operation.

Referring to FIG. 1, the operation knob 150 is pivoted downward to make the tension spring central axis 120 into the first position, pivoted horizontally to make the tension spring central axis 120 into the second position, and pivoted upward to make the tension spring central axis 120 into the third position.

In the first position, the first male gear 131 is meshed with a half of the first female gear 141, and the second male gear 132 and the second female gear 142 are released from meshed engagement with each other, as well as the tension spring central axis 120 is fixed and the winding pipe 143 is allowed to rotate, thereby resulting in a normal state in which unwinding and winding of the awning sheet 110 is allowed. When all of the first and second male gears 130 and the first and second female gears 140 are meshed in the second position, both the tension spring central axis 120 and the winding pipe 143 are fixed, thereby resulting in a fixed state in which unwinding or winding of the awning sheet 110 is prevented. Such the case is used when it is necessary to fix the unwound sheet, and since both the first and second male gears 130 and the first and second female gears 140 are released from meshed engagement and separated from each other in the third position, the rotational force of the tension spring 125 may be directly adjusted by the operation knob 150. In this case, when the rotational force of the tension spring is weakened or too strong for some reasons, the rotational force thereof may be adjusted by addition or subtraction using the operation knob.

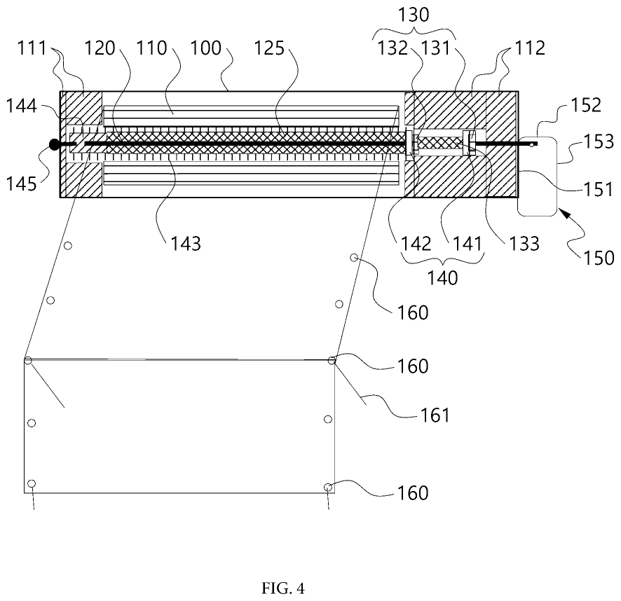

FIG. 4 shows a state in which the awning sheet 110 is withdrawn from the body case 100, which is the same state as shown in FIG. 1, and may refer to a state in which the awning sheet is normally unwound. At this time, as shown in FIG. 4, the ends of the awning sheet may be fixed close to the ground, or if a large space is desired by the user, poles 161 in the middle may be inserted into the punching holes 160 at the end of the awning sheet, and vice versa, such that the awning sheet may be withdrawn a little and used more narrowly.

Although the present invention has been described with reference to the embodiments shown in the drawings, these are merely an example. It should be understood by persons having common knowledge in the technical field to which the present invention pertains that various modifications of the embodiments may be made, and such modifications are included in the technical protection scope of the present invention. Accordingly, the real technical protection scope of the present invention is determined by the technical spirit of the appended claims.

### DESCRIPTION OF REFERENCE NUMERALS

100: Body case
110: Awning sheet
111: First axis fixing part
112: Second axis fixing part
120: Tension spring central axis
125: Tension spring
130: Plurality of male gears
131: First male gear
132: Second male gear
133: Compression spring
140: Plurality of female gears
141: First female gear
142: Second female gear
143: Winding pipe
144: Pipe-spring connector
145: Coupling screw
150: Operation knob
151: First contact section
152: Second contact section
153: Third contact section
160: Awning sheet punching hole
161: Pole

What is claimed is:

1. A semi-automatic awning with a spring comprising:
a body case which comprises an awning sheet wound and accommodated therein, an opening formed on a front side for withdrawing the awning sheet, side openings formed at opposite ends thereof, and axis fixing parts configured to close the side openings, to which axes are coupled inside thereof;
a winding pipe rotatably installed in a first axis fixing part on one side of the body case, and having a hollow shape in which the awning sheet is wound;
a pipe-spring connector configured to connect the winding pipe and the tension spring, rotatably coupled to the first axis fixing part by a screw, and coupled to the tension spring;
a tension spring central axis which is rotatably and slidely accommodated in the pipe-spring connector, and extends through an opening on the other side of the body case along a center line of the body case;
a tension spring coupled to the tension spring central axis and the pipe-spring connector, accommodated in the winding pipe while surrounding the tension spring central axis, and actuated to apply a rotational force of the tension spring to the winding pipe;
a plurality of male gears located adjacent to a second axis fixing part on the other side of the body case, coupled to one end of the tension spring central axis at a predetermined interval, and having a circular outer gear shape;
a plurality of female gears respectively installed on the winding pipe and the second axis fixing part of the body case, arranged at positions corresponding to the plurality of male gears, and having a circular inner gear shape; and
an operation knob which is pivotably and eccentrically coupled to one end of the tension spring central axis adjacent to the plurality of male gears and female gears on an outside of the body case, and is configured to move the tension spring central axis to any one of a first position where one of the plurality of male gears is meshed with a female gear provided in the second axis fixing part, a second position where all of the plurality of male gears and female gears are meshed with each other, and a third position where all of the plurality of male gears and female gears are separated from each other,
wherein in the first position, rotation of the winding pipe is allowed and rotation of the tension spring central axis is prevented, in the second position, rotations of both the winding pipe and tension spring central axis are prevented, and in the third position, the rotational force of the tension spring is adjusted by rotating the tension spring central axis.

2. The semi-automatic awning with a spring according to claim 1, wherein the plurality of male gears comprises a first male gear and a second male gear, and
further comprising a compression spring configured to firmly support a movement of the tension spring central axis in which the plurality of male gears are provided.

3. The semi-automatic awning with a spring according to claim 2, wherein the female gear comprises a first female gear located in the second axis fixing part and a second female gear located in the winding pipe, and
the first female gear is a gear formed longer than the second female gear so that all the plurality of male gears and female gears are meshed with each other in a state in which the tension spring central axis is converted from the first position to the second position.

4. The semi-automatic awning with a spring according to any one of claim 3, wherein the operation knob comprise:
a first contact section configured to contact with the second axis fixing part by moving the tension spring central axis with respect to a rotation central portion rotatably coupled to the tension spring central axis to make it into the first position;
a second contact section disposed to cross the first contact section at a right angle, and configured to move the tension spring central axis into the second position; and
a third contact section disposed to cross the second contact section at a right angle, and configured to move the tension spring central axis into the third position.

5. The semi-automatic awning with a spring according to claim 4, wherein the operation knob includes the first, second and third contact sections, and has a rectangular block shape having rounded corners for pivot operation.

6. The semi-automatic awning with a spring according to any one of claim 2, wherein the operation knob comprise:
a first contact section configured to contact with the second axis fixing part by moving the tension spring central axis with respect to a rotation central portion rotatably coupled to the tension spring central axis to make it into the first position;
a second contact section disposed to cross the first contact section at a right angle, and configured to move the tension spring central axis into the second position; and
a third contact section disposed to cross the second contact section at a right angle, and configured to move the tension spring central axis into the third position.

7. The semi-automatic awning with a spring according to claim 6, wherein the operation knob includes the first, second and third contact sections, and has a rectangular block shape having rounded corners for pivot operation.

8. The semi-automatic awning with a spring according to any one of claim 1, wherein the operation knob comprise:
a first contact section configured to contact with the second axis fixing part by moving the tension spring central axis with respect to a rotation central portion rotatably coupled to the tension spring central axis to make it into the first position;
a second contact section disposed to cross the first contact section at a right angle, and configured to move the tension spring central axis into the second position; and
a third contact section disposed to cross the second contact section at a right angle, and configured to move the tension spring central axis into the third position.

9. The semi-automatic awning with a spring according to claim 8, wherein the operation knob includes the first, second and third contact sections, and has a rectangular block shape having rounded corners for pivot operation.

10. The semi-automatic awning with a spring according to claim 1, poles are installed at free positions using a plurality of punched holes formed on left and right sides of the awning sheet.
